(19) United States
(12) Patent Application Publication
(10) Pub. No.: US 2008/0273826 A1
(43) Pub. Date: Nov. 6, 2008

(54) Wheel axle dismounting device

(76) Inventor: Michael Muller, Kups (DE)

Correspondence Address: ROSENBERG, KLEIN & LEE, 3458 ELLICOTT CENTER DRIVE-SUITE 101, ELLICOTT CITY, MD, 21043, US

(21) Appl. No.: 11/797,107

(22) Filed: May 1, 2007

(51) Int. Cl. F16C 19/10

(52) U.S. Cl. 384/609

(57) ABSTRACT

A wheel axle dismounting device includes a rod screw with a head portion; a screw cylinder with a concave portion and mounted on the rod screw; a pushing element mounted on the rod screw for pushing a wheel axle; a combining element mounted on the rod screw; a fixing cylinder with an accommodation space and penetrated through by the rod screw; a first thrust bearing with a first end portion and a second end portion that can rotate with respect to each other, mounted by the head portion of the rod screw; and a second thrust bearing with a third end portion and a fourth end portion that can rotate with respect to each other, mounted in the concave portion of the screw cylinder. The user can rotate the rod screw and the screw cylinder to readily mount and dismount the wheel axle, with the first thrust bearing and the second thrust bearing providing an upward force.

### BACKGROUND OF THE INVENTION

1. Field of Invention

The invention relates to a wheel axle dismounting device and, in particular, to a device that can readily dismount the wheel axle using a thrust bearing.

2. Related Art

FIG. 5 shows a conventional wheel axle dismounting device. It has a rod screw 40, whose left end is threaded with a screw cap 41 that can screw in and out with respect to the rod screw 40. The rod screw 40 is further mounted with a pushing element 42. The right end of the pushing element 42 pushes against the left end of a wheel axle 43. The left end of the pushing element 42 pushes against the screw cap 41. The other end of the rod screw 40 is mounted with a combining element 44. The left end of the combining element 44 has a protruding structure 441. The right end of the combining element 44 pushes against the left side of a hear portion 401 of the rod screw 40. The protruding structure 441 of the combining element 44 is fixed with a fixing cylinder 45 on the rod screw 40. The left end of the fixing cylinder 45 pushes against the outer side of the angle 46 of the wheel axle 43.

To dismount the wheel axle 43, the user turns the rod screw 40 and the screw cylinder 41. Under the push of the screw cylinder 41, the pushing element 42 pushes the wheel axle 43 away from the angle 46. This action dismounts the wheel axle 43.

As mentioned above, the screw cylinder 41 is in direct contact with the pushing element 42 for dismounting the wheel axle 43. When the screw cylinder 41 is rotated, there is a friction between the pushing element 42 and the screw cylinder 41. The rotation is thus unsmooth. Moreover, this results in erosion of the screw cylinder 43 and the pushing element 42. This problem also exists between the head portion 401 of the rod screw 40 and the combing element. The same problems also exist when one wants to mount the wheel axle 43. It is therefore desirable to provide a solution.

### SUMMARY OF THE INVENTION

An objective of the invention is to provide a wheel axle dismounting device that can prevent the above-mentioned problems. Two thrust bearings are used to provide an axial support for the screw cylinder and the rod screw, so that the wheel axle can be smoothly mounted or dismounted.

Another objective of the invention is to use two thrust bearings to provide an axial support for the screw cylinder and the rod screw, so that the friction and erosion thereof can be reduced.

To achieve the above-mentioned objectives, the invention includes a rod screw, a combing element, a fixing cylinder, a pushing element, and a screw cylinder. The rod screw has a rod body and a hear portion on one end of the rod body. The combining element has a through hole in the middle, a protruding structure on one side, and an accommodating room on the other side. The rod screw goes through the accommodating room and the through hole to mount the combining element on the rod body. The accommodating room is pushed by the head portion. The fixing cylinder has an accommodation space. The rod screw goes through the accommodation space. One end of the fixing cylinder is fixed with the protruding structure of the combining element. The other end of the fixing cylinder pushes against one side of an angle. The pushing element has a through hole in the middle, a protruding edge on one end to surround the through hole. The pushing element is mounted on the screw body using the through hole. The pushing element pushes against one end of a wheel axle using the end opposite to the protruding edge. The screw cylinder has a screw hole in the axial direction. The screw cylinder is mounted on the rod body with one end touching against the protruding edge of the pushing element.

The invention has the following improvements. A first trust bearing is provided in the vicinity of the hear portion of the rod body. The first thrust bearing comprises a first end portion, a second end portion, and a first ball element. The first ball element is disposed between the first end portion and the second end portion for them to rotate with respect to each other. The outer side of the first end portion touches against one side of the hear portion in the vicinity of the smooth rod body. The outer side of the second end portion touches against the inner wall of the accommodating room of the combining element.

One side of the screw cylinder has a concave portion disposed with a second thrust bearing. The second thrust bearing comprises a third end portion, a fourth end portion, and a second ball element. The second ball element is disposed between the third end portion and the fourth end portion for them to rotate with respect to each other. The third end portion touches against the protruding edge of the pushing element. The fourth end portion touches against the bottom surface in the concave portion.

The user can rotate the rod screw and the screw cylinder so that the pushing element is forced to push the wheel axle and dismount it.

### BRIEF DESCRIPTION OF THE DRAWINGS

The invention will become more fully understood from the detailed description given herein below illustration only, and thus is not limitative of the present invention, and wherein:

FIG. 1 is a schematic three-dimensional view of the invention;

FIG. 2 is a cross-sectional view of the disclosed dismounting device along with the wheel axle and the angle;

FIG. 3 is a cross-sectional view of dismounting the wheel axle on the angle;

FIG. 4 is a cross-sectional view of mounting the wheel axle on the angle; and

FIG. 5 is a cross-sectional view of a conventional wheel axle dismounting device along with the angle.

### DETAILED DESCRIPTION OF THE INVENTION

The present invention will be apparent from the following detailed description, which proceeds with reference to the accompanying drawings, wherein the same references relate to the same elements.

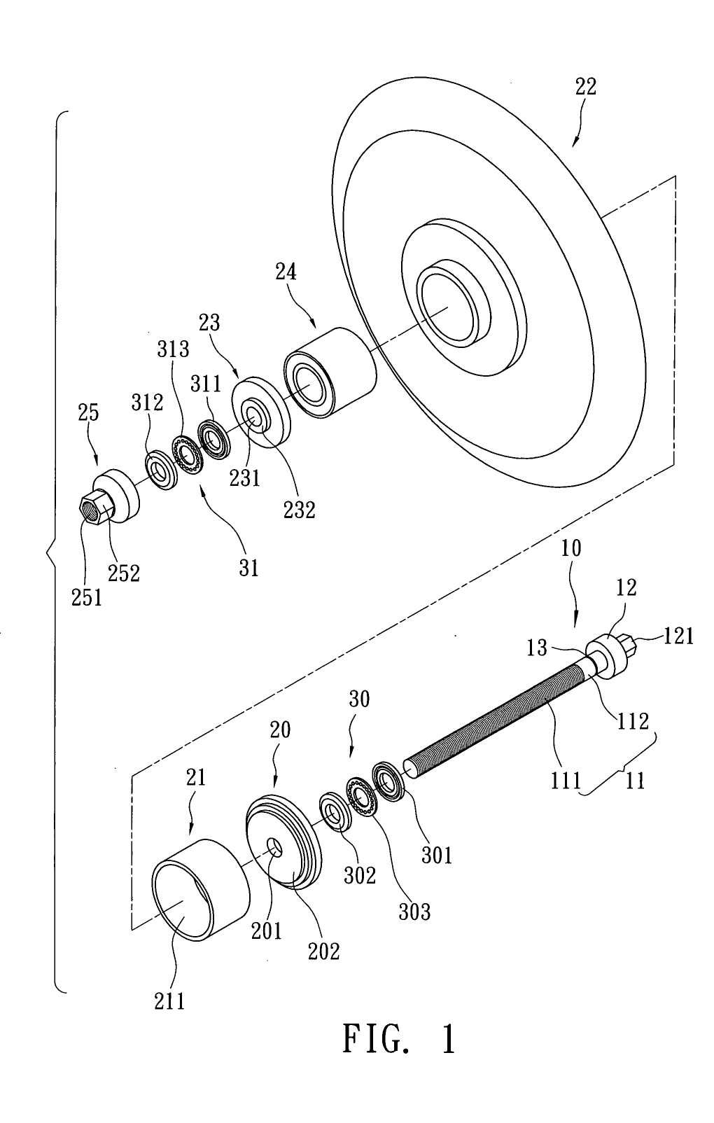

An embodiment of the invention is shown in FIGS. 1 to 4 for the purpose of illustration. The scope of the invention, however, is not limited by this example.

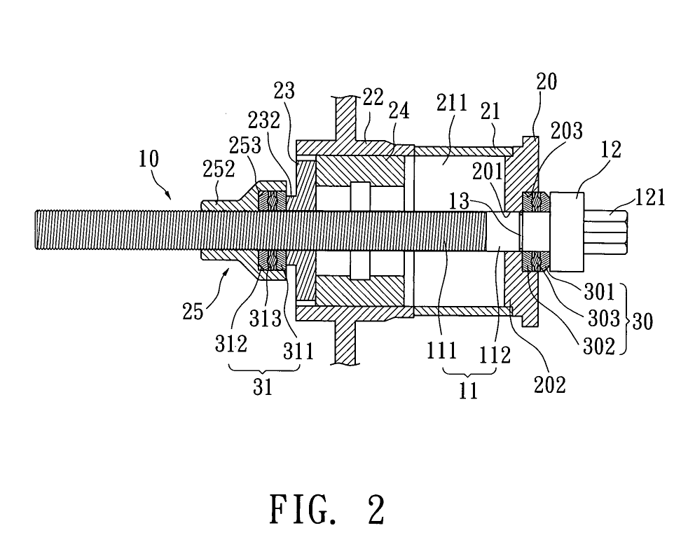

As shown in FIGS. 1 and 2, the disclosed wheel axle dismounting device includes: a rod screw 10, a combining element 20, a fixing cylinder 21, a pushing element 23, and a screw cylinder 25.

The rod screw 10 has a rod body 11 and a head portion 12 on one end of the rod body 11. The rod body 11 consists of at least a screw rod body 111 and a smooth rod body 112. The smooth rod body 112 is between the screw rod body 111 and the head portion 12. The smooth rod body 112 is shorter than the screw rod body 111. A first turning part 121 is provided on the end of the rod body 11 that is opposite to the head portion 12 for rotating the rod screw 10.

The combining element 20 has a through hole 201 penetrating along its central axis. A protruding structure 202 is formed on one side of the combining element 20. A ladder-shaped structure is formed around the protruding structure 202. An accommodation room 203 is formed on the other side of the combining element 20. The rod screw 10 goes through the accommodation room 203 and the through hole 201. The combining element 20 is thereby mounted on the rod body 11 of the rod screw 10. The accommodation room 203 is depressed by the head portion 12.

The fixing cylinder 21 has an accommodation space 211. The rod screw 10 goes through the accommodation space 211. The edge of one end of the fixing cylinder 21 matches with the ladder-shaped structure of the protruding structure 202 of the combining element 20. The edge of the other end of the fixing cylinder 21 touches against one side of an angle 22.

The pushing element 23 has a through hole 231 penetrating along its central axis. One side of the pushing element 23 is a protruding edge 232, formed around the through hole 231. The pushing element 23 is mounted on the rod body 11 of the rod screw using the through hole 231. The other side of the pushing element 23 touches against one side of a wheel axle 24.

The screw cylinder 25 has a screw hole 251 penetrating along its axial direction. A second turning part 252 for turning the screw cylinder 25 is formed around it. The screw cylinder 25 is screw-fastened on the screw rod body 111 of the rod body 11. After the rod screw 10 goes through the screw cylinder 25, its one side touches against the protruding edge 232 of the pushing element 23.

The invention has the following features. A first thrust bearing 30 is provided in the vicinity of the head portion 12 on the rod body 11. A fixing element 13 is provided around the smooth rod body 112. The fixing element 13 in this embodiment is an O ring. The first thrust bearing 30 is mounted on the smooth rod body 112 between the fixing element 13 and the head portion 12. The first thrust bearing 30 consists of at least a first end part 301, a second end part 302, and a first ball element 303. The first ball element 303 is disposed between the first and second end parts 301, 302 for them to rotate with respect to each other. The outer side of the first end part 301 touches against one side of the head portion 121 that is closer to the smooth rod body 112. The outer side of the second end part 302 touches against the inner wall of the accommodation room 203 of the combining element 20.

A concave portion 253 is formed on one side of the screw cylinder 25. The opening of the screw hole 251 is formed at the bottom center inside the concave portion. A second thrust bearing 31 is disposed in the concave portion 253. The second thrust bearing 31 consists of at least a third end part 311, a fourth end part 312, and a second ball element 313. The second ball element 313 is disposed between the third and fourth end parts 311, 312 for them to rotate with respect to each other. The third end part 311 touches against the outer side of the protruding edge 232 of the pushing element. The fourth end part 312 touches against the inner bottom surface of the concave portion 253.

The user rotates the rod screw 10 and the screw cylinder 25 to drive the pushing element 23 to push the wheel axle 24. The first thrust bearing is disposed between the accommodation room 203 of the combining element 20 and the head portion 12. The second thrust bearing 31 is disposed between the concave portion 253 of the screw cylinder 25 and the protruding edge 232 of the pushing element 23. As the rod screw 10 turns, an axially upward force is produced to dismount the wheel axle 24.

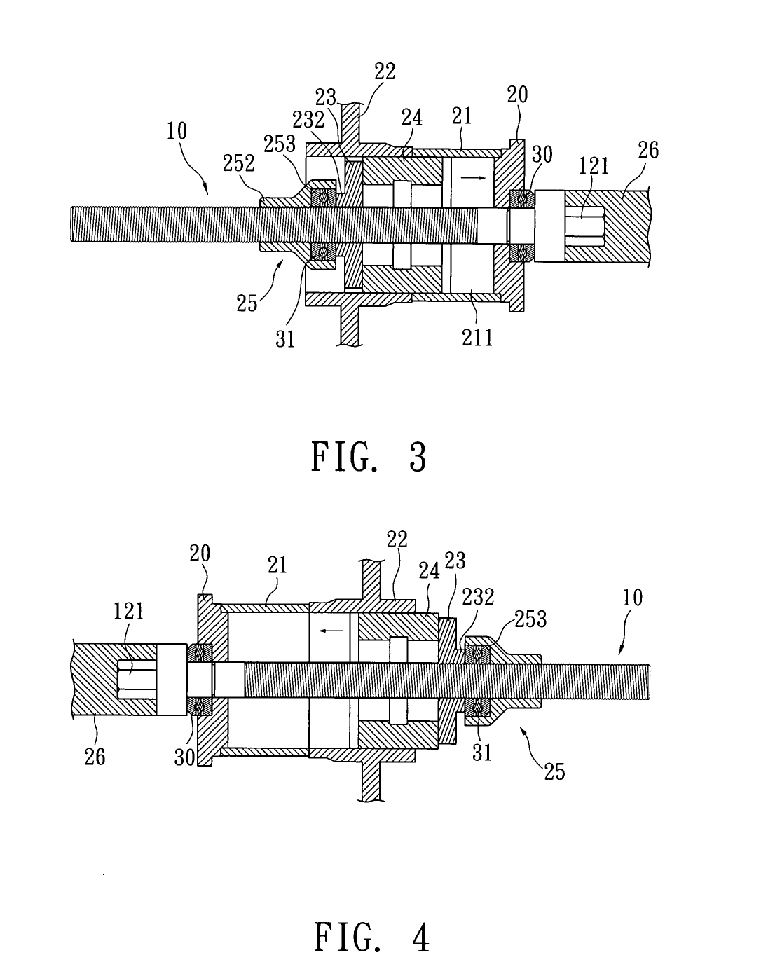

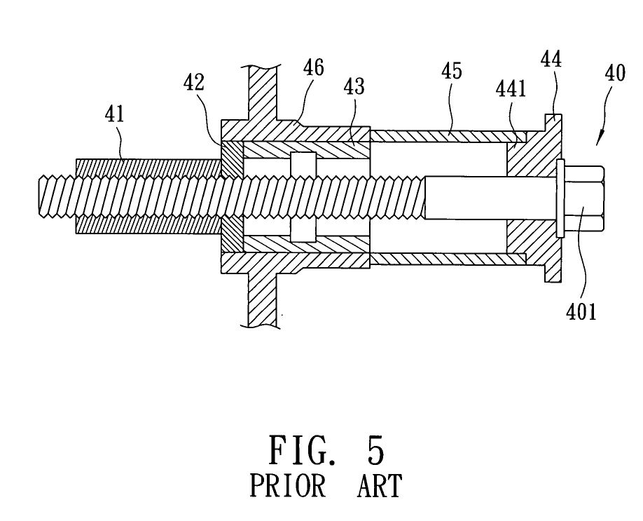

The following describes how the wheel axle is mounted and dismounted. FIG. 3 shows how the wheel axle 24 is dismounted. The user mounts a cylinder 26 on the first turning part 121 to rotate the rod screw 10. The user then uses another tool (not shown) to turn the second turning part 252 for rotating the screw cylinder 25. A pushing relation exists between the second thrust bearing 31 in the concave portion 253 of the screw cylinder 25 and the protruding edge 232 of the pushing element 23. The pushing element 23 pushes the wheel axle 24 so that the wheel axle 24 departs from the angle 22. Moreover, the wheel axle 24 goes into the accommodation space 211 of the fixing cylinder 21 after the departure from the angle 22.

FIG. 4 shows how the wheel axle 24 is mounted. By turning the rod screw 10 and the screw cylinder 25, the second thrust bearing 31 in the concave portion 253 of the screw cylinder 25 pushes the protruding edge 232 of the pushing element 23 and the pushing element 23 in turn pushes the wheel axle 24. Therefore, the wheel axle 24 is pushed into the angle 22.

In summary, the disclosed wheel axle dismounting device uses the first thrust bearing 31 and the second thrust bearing 32 to increase the smoothness and convenience in mounting and dismounting the wheel axle 24 on the angle 22. The invention prevents the problem of erosion due to friction between the screw cylinder 25 and the pushing element 23 and between the combining element 20 and the head portion 12 of the rod screw 10 after long time turning. This elongates the lifetime of the wheel axle dismounting device.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A wheel axle dismounting device comprising:
a rod screw, which has a rod body and a head portion on one end of the rod body;
a combining element, which has a through hole formed at its center, a protruding structure on one side, and an accommodating room on the other side, the rod screw going through the accommodating room and the through hole so that the combining element is mounted on the rod body, and the accommodating room being pressed by the head portion;
a fixing cylinder, which has an accommodation space for the rod screw to go through, one side fixed on the protruding structure of the combining element, and the other side touching against one side of an angle;
a pushing element, which has a through hole at its center so as to be mounted on the rod body, a protruding edge on its one side formed around the through hole, and use its other side to touch one side of a wheel axle;
a screw cylinder, which has a screw hole formed along its axial direction, is mounted on the rod body, and uses its one side to touch the protruding edge of the pushing element;
wherein a first thrust bearing is disposed in the vicinity of the head portion of the rod body, the first thrust bearing includes at least a first end portion, a second end portion, and a first ball element disposed between the first and second end portions for them to rotate with respect to each other, the outer side of the first end portion touches against the side of the head portion that is close to the smooth rod body, and the outer side of the second end portion touches against the inner wall of the accommodating room of the combining element;
one side of the screw cylinder has a concave portion disposed with a second thrust bearing, the second thrust bearing includes at least a third end portion, a fourth end portion, and a second ball element disposed between the third and fourth end portions for them to rotate with respect to each other, the third end portion touches against the protruding edge of the pushing element, and the fourth end portion touches against the inner bottom surface of the concave portion; and
the rod screw and the screw cylinder are turned to drive the pushing element to push the wheel axle for mounting and dismounting.

2. The wheel axle dismounting device of claim 1, wherein the rod body includes at least a screw rod body and a smooth rod body with the smooth rod body disposed between the screw rod body and the head portion, the smooth rod body is provided with a fixing element, and the first thrust bearing is disposed on the smooth rod body between the fixing element and the head portion.

3. The wheel axle dismounting device of claim 2, wherein the fixing element is an O ring.

4. The wheel axle dismounting device of claim 1, wherein a first turning part is provided on one side of the head portion that is different from the rod body.

5. The wheel axle dismounting device of claim 1, wherein a second turning part is formed around the screw cylinder.
